(19) United States
(12) Patent Application Publication
(10) Pub. No.: US 2024/0332605 A1
(43) Pub. Date: Oct. 3, 2024

(54) SOLID STATE BATTERY AND METHOD OF MANUFACTURING SOLID STATE BATTERY

(71) Applicant: HONDA MOTOR CO., LTD., Tokyo (JP)

(72) Inventors: Takashi NAKAGAWA, Saitama (JP); Kyohei IZUMI, Saitama (JP)

(21) Appl. No.: 18/586,568

(22) Filed: Feb. 26, 2024

(30) Foreign Application Priority Data
Mar. 31, 2023 (JP) 2023-059223

(51) Int. Cl. H01M 10/0562; H01M 10/052; H01M 10/0585

(52) U.S. Cl. CPC H01M 10/0562; H01M 10/052; H01M 10/0585; H01M 2300/0068

(57) ABSTRACT

A solid state battery includes an electrode laminate including an intermediate layer, a first solid electrolyte layer, a positive electrode, and a second solid electrolyte layer sequentially laminated on a negative electrode. The positive electrode includes a positive electrode tab extending therefrom. One of the first solid electrolyte layer or the second solid electrolyte layer includes a porous substrate. One other of the first solid electrolyte layer or the second solid electrolyte layer does not include a porous substrate. When the electrode laminate is viewed from above, outer peripheral ends of the first solid electrolyte layer and the second solid electrolyte layer are located outside an outer peripheral end of the positive electrode, and the first solid electrolyte layer and the second solid electrolyte layer are bonded to each other in a region not opposed to the positive electrode and the positive electrode tab.

This application is based on and claims the benefit of priority from Japanese Patent Application No. 2023-059223, filed on 31 Mar. 2023, the content of which is incorporated herein by reference.

### BACKGROUND OF THE INVENTION

### Field of the Invention

The present invention relates to a solid state battery and a method of manufacturing the solid state battery.

### Related Art

In recent years, research and development have been carried out on battery modules that contribute to energy efficiency in order for many people to be able to ensure access to energy that is reasonable, reliable, sustainable, and advanced.

Patent Document 1 describes an all-solid state battery including a positive electrode piece including a positive electrode active material layer on a positive electrode collector layer, a negative electrode piece including a negative electrode active material layer on a negative electrode collector layer, and a bag-shaped solid electrolyte layer accommodating the positive electrode piece. Here, the positive electrode active material layer and the negative electrode active material layer are disposed so as to face each other with the solid electrolyte layer interposed therebetween by laminating the positive electrode piece and the negative electrode piece accommodated in the bag-shaped solid electrolyte layer so as to overlap each other in a plan view.
Patent Document 1: Japanese Unexamined Patent Application, Publication No. 2020-181668

### SUMMARY OF THE INVENTION

However, in the all-solid state battery described in Patent Document 1, there is a possibility that a short circuit occurs because a partition is not provided which separates end portions of the positive electrode piece and the negative electrode piece having the bag-shaped solid electrolyte layer interposed therebetween.

It is an object of the present invention to provide a solid state battery capable of suppressing the occurrence of a short circuit.

(1) A solid state battery including: an electrode laminate including an intermediate layer, a first solid electrolyte layer, a positive electrode, and a second solid electrolyte layer sequentially laminated on a negative electrode, in which the positive electrode includes a positive electrode tab extending therefrom, one of the first solid electrolyte layer or the second solid electrolyte layer includes a porous substrate, one other of the first solid electrolyte layer or the second solid electrolyte layer does not include a porous substrate, when the electrode laminate is viewed from above, outer peripheral ends of the first solid electrolyte layer and the second solid electrolyte layer are located outside an outer peripheral end of the positive electrode, and the first solid electrolyte layer and the second solid electrolyte layer are bonded to each other in a region not opposed to the positive electrode and the positive electrode tab.

(2) The solid state battery according to (1), in which the positive electrode includes a positive electrode collector and positive electrode mixture layers on both surfaces of the positive electrode collector, and the electrode laminate includes the intermediate layer, the first solid electrolyte layer, the positive electrode, the second solid electrolyte layer, a second intermediate layer, and a second negative electrode sequentially laminated on the negative electrode.

(3) The solid state battery according to (1) or (2), in which the positive electrode includes an outer peripheral portion including an insulating frame provided thereon, when the electrode laminate is viewed from above, outer peripheral ends of the first solid electrolyte layer and the second solid electrolyte layer are located outside an outer peripheral end of the insulating frame, and the first solid electrolyte layer and the second solid electrolyte layer are bonded to each other in a region not opposed to the insulating frame.

(4) The solid state battery according to any one of (1) to (3), in which the negative electrode includes a lithium metal layer.

(5) The solid state battery according to any one of (1) to (4), in which the intermediate layer includes a metal capable of being alloyed with lithium and amorphous carbon.

(6) A method of manufacturing a solid state battery according to any one of (1) to (5), the method including: sequentially laminating a first solid electrolyte layer, a positive electrode, and a second solid electrolyte layer; and applying a pressure from a side of the other of the first solid electrolyte layer or the second solid electrolyte layer to bond the first solid electrolyte layer and the second electrolyte layer.

(7) A solid state battery including: an electrode laminate including a first solid electrolyte layer, an intermediate layer, a negative electrode, and a second solid electrolyte layer sequentially laminated on a positive electrode, in which the negative electrode includes a negative electrode tab extending therefrom, one of the first solid electrolyte layer or the second solid electrolyte layer includes a porous substrate, one other of the first solid electrolyte layer or the second solid electrolyte layer does not include a porous substrate, when the electrode laminate is viewed from above, outer peripheral ends of the first solid electrolyte layer and the second solid electrolyte layer are located outside outer peripheral ends of the intermediate layer and the negative electrode, and the first solid electrolyte layer and the second solid electrolyte layer are bonded to each other in a region not opposed to the intermediate layer, the negative electrode and the negative electrode tab.

According to embodiments of the present invention, it is possible to provide a solid state battery capable of suppressing the occurrence of a short circuit.

### BRIEF DESCRIPTION OF THE DRAWINGS

FIG. 1 is a perspective view showing an example of a solid state battery according to an embodiment of the present invention;

FIG. 2 is an enlarged top view of the solid state battery of FIG. 1;

FIG. 3 is an exploded perspective view of the solid state battery of FIG. 1;

FIG. 4 is a cross-sectional view taken along the line A-A of FIG. 2;

FIG. 5 is a cross-sectional view taken along the line B-B of FIG. 2; and

FIG. 6 is a cross-sectional view showing a modified example of a laminated structure of an electrode laminate.

### DETAILED DESCRIPTION OF THE INVENTION

Hereinafter, embodiments of the present invention will be described with reference to the accompanying drawings.

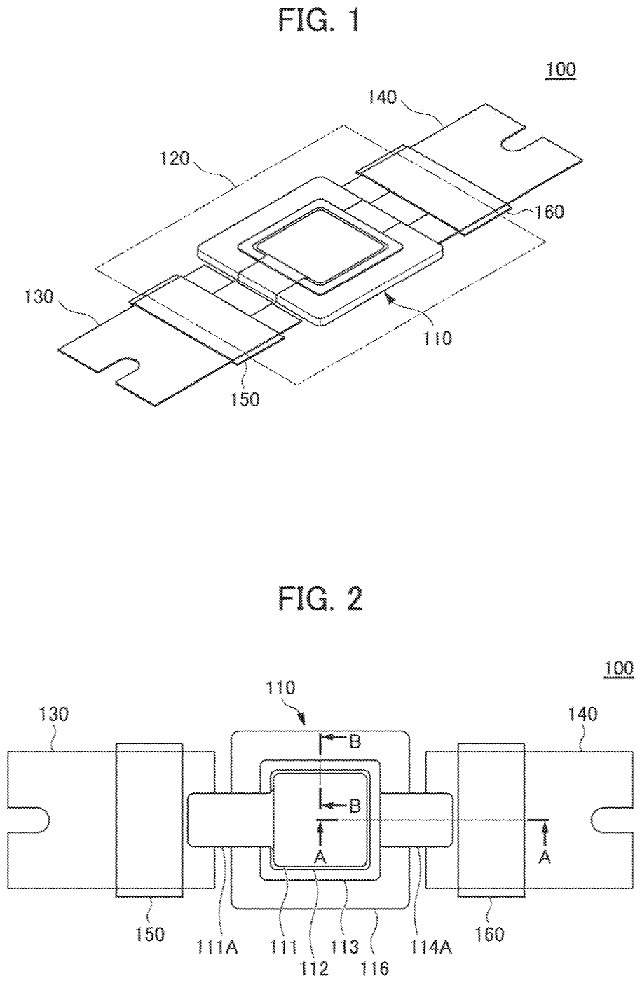

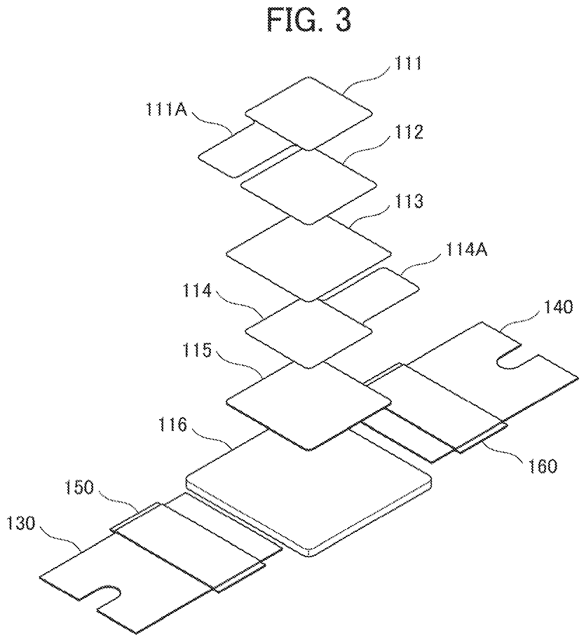

FIGS. 1 to 3 each show an example of a solid state battery of an embodiment of the present invention.

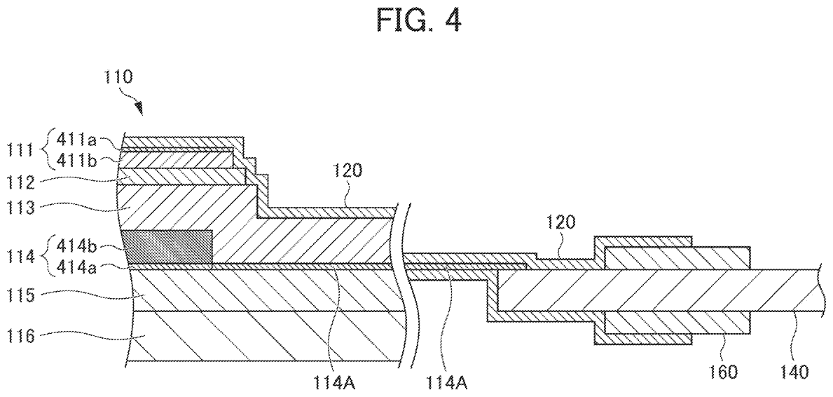

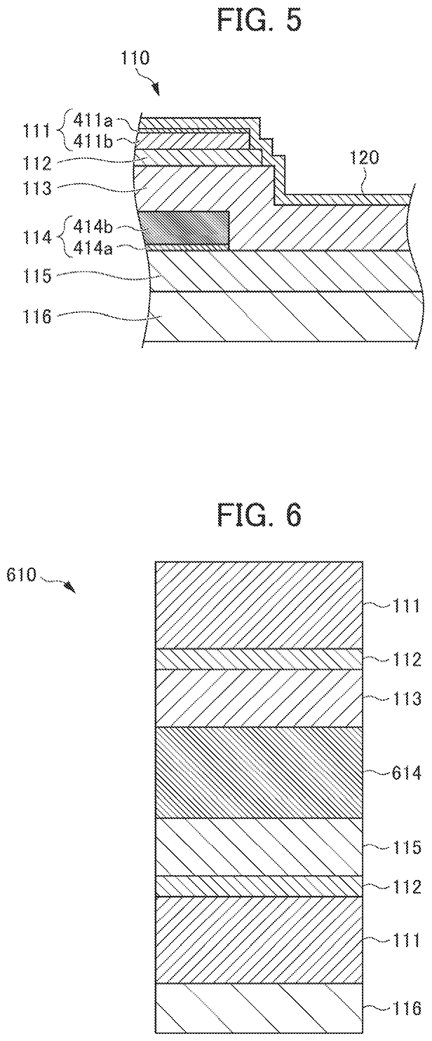

A solid state battery 100 includes an electrode laminate 110. The electrode laminate 110 includes an intermediate layer 112, a first solid electrolyte layer 113, a positive electrode 114, a second solid electrolyte layer 115, and a substrate 116 sequentially laminated on a negative electrode 111. The electrode laminate 110 is packaged with a laminate film 120 serving as a packaging material. Further, in the solid state battery 100, the negative electrode 111 includes a negative electrode tab 111A extending therefrom, and the positive electrode 114 includes a positive electrode tab 114A extending therefrom. The direction in which the negative electrode tab 111A extends is opposite to the direction in which the positive electrode tab 114A extends. Further, the first solid electrolyte layer 113 does not include a porous substrate, and the second solid electrolyte layer 115 includes a porous substrate. When the electrode laminate 110 is viewed from above, the outer peripheral ends of the first solid electrolyte layer 113 and the second solid electrolyte layer 115 are located outside the outer peripheral end of the positive electrode 114, and the first solid electrolyte layer 113 and the second solid electrolyte layer 115 are bonded to each other in a region not opposed to the positive electrode 114 and the positive electrode tab 114A (see FIGS. 4 and 5). Therefore, since the end portion of the negative electrode 111 and the end portion of the positive electrode 114 are separated from each other by the first solid electrolyte layer 113, it is possible to suppress the occurrence of a short circuit. Further, it is also possible to suppress the positional displacement between the positive electrode 114 and the first solid electrolyte layer 113 and drop-off of the positive electrode 114.

When the positive electrode tab 114A is a porous body, the first solid electrolyte layer 113 and the second solid electrolyte layer 115 can be bonded even in a region facing the positive electrode tab 114A.

The solid electrolytes of the first solid electrolyte layer 113 and the second solid electrolyte layer 115 may be different from each other, but the solid electrolytes of them are preferably the same in consideration of bonding properties of the first solid electrolyte layer 113 and the second solid electrolyte layer 115.

The first solid electrolyte layer 113 is formed by, for example, a transfer method or a coating method.

The porous substrate of the second solid electrolyte layer 115 is not particularly limited as long as it can be filled with the solid electrolyte, but examples thereof include nonwoven fabrics.

The method of bonding the first solid electrolyte layer 113 and the second solid electrolyte layer 115 is not particularly limited, but examples thereof include a method in which the intermediate layer 112, the first solid electrolyte layer 113, the positive electrode 114, the second solid electrolyte layer 115, and the substrate 116 are sequentially laminated on the negative electrode 111, and then a pressure is applied from the side of the first solid electrolyte layer 113, i.e., the side of the negative electrode 111. At this time, pressure may be applied while heating, if necessary.

The bonding the first solid electrolyte layer 113 and the second solid electrolyte layer 115 may be performed before the electrode laminate 110 is packaged with the laminate film 120, or may be performed when the electrode laminate 110 is packaged with the laminate film 120.

The material of the substrate 116 is not particularly limited as long as it is a material having high rigidity, and examples thereof include stainless steel.

Alternatively, the order in which the first solid electrolyte layer 113 and the second solid electrolyte layer 115 are laminated may be reversed, and a pressure may be applied from the side of the first solid electrolyte layer 113, i.e., the side of the substrate 116.

Alternatively, after sequentially laminating the first solid electrolyte layer 113, the positive electrode 114, and the second solid electrolyte layer 115, a pressure may be applied from the side of the first solid electrolyte layer 113 to manufacture the first solid electrolyte layer-positive electrode-second solid electrolyte layer laminate in advance. In this case, in the electrode laminate 110, the order in which the first solid electrolyte layer 113 and the second solid electrolyte layer 115 are laminated may be reversed.

The negative electrode 111 includes a negative electrode collector 411a and a negative electrode mixture layer 411b provided on one surface of the negative electrode collector 411a. The positive electrode 114 includes a positive electrode collector 414a and a positive electrode mixture layer 414b provided on one surface of the positive electrode collector 414a. Further, the negative electrode tab 111A is connected to a negative electrode tab lead 130, and the positive electrode tab 114A is connected to a positive electrode tab lead 140. Further, the negative electrode tab lead 130 is bonded to the laminate film 120 by a sealant 150, and the positive electrode tab lead 140 is bonded to the laminate film 120 by a sealant 160.

For example, when the solid state battery 100 is a lithium metal secondary battery, the intermediate layer 112 has a function of uniformly depositing lithium metal. Therefore, the interface between the intermediate layer 112 and the first solid electrolyte layer 113 is stabilized. Here, the lithium metal secondary battery may be an anode free battery in which the negative electrode mixture layer 411b does not exist during the first charge. In this case, after the first charge and discharge, a lithium metal layer is formed as the negative electrode mixture layer 411b.

The intermediate layer 112 is not particularly limited, but includes, for example, a metal capable of being alloyed with lithium and amorphous carbon. Examples of the amorphous carbon include carbon blacks such as acetylene black, furnace black, and Ketjenblack, coke, and activated carbon. The amorphous carbon may be graphitizable carbon (soft carbon), non-graphitizable carbon (hard carbon), CNT (carbon nanotube), fullerene, or graphene. Examples of metals that can be alloyed with lithium include tin (Sn), silicon (Si), zinc (Zn), magnesium (Mg), gold (Au), platinum (Pt), palladium (Pd), silver (Ag), aluminum (Al), bismuth (Bi), antimony (Sb), and the like. The metal capable of being alloyed with lithium may be nanoparticles.

The intermediate layer 112 is formed by, for example, a transfer method or a coating method.

The laminate film 120 includes, for example, a metal layer provided on a surface of a resin layer. Examples of the resin include polyethylene, polyvinyl fluoride, and polyvinylidene chloride, and examples of the metal include aluminum.

The positive electrode 114 may include an outer peripheral portion including an insulating frame provided thereon. With such a configuration, it is possible to suppress the occurrence of a short circuit. In this case, when the electrode laminate 110 is viewed from above, the outer peripheral edges of the first solid electrolyte layer 113 and the second solid electrolyte layer 115 exist outside the outer peripheral edges of the positive electrode 114 and the insulating frame, and the first solid electrolyte layer 113 and the second solid electrolyte layer 115 are bonded to each other in a region not opposed to the positive electrode 114, the positive electrode tab 114A, and the insulating frame.

The material of the insulating frame is not particularly limited as long as it has electron insulating properties, and examples thereof include insulating oxides such as alumina, resins such as polyvinylidene fluoride (PVDF), and rubbers such as styrene-butadiene rubber (SBR).

The insulating frame may have ion conductivity.

FIG. 6 shows a modified example of the laminated structure of the electrode laminate.

An electrode laminate 610 is the same as the electrode laminate 110 except that the positive electrode 614 is used instead of the positive electrode 114, and the intermediate layer 112 and the negative electrode 111 are further disposed between the second solid electrolyte layer 115 and the substrate 116. Here, the positive electrode 614 includes positive electrode mixture layers provided on both surfaces of a positive electrode collector, for example.

The negative electrodes 111 and the intermediate layer 112 provided on both sides of the positive electrode 614 may be the same or different. Further, the positive electrode mixture layers provided on both surfaces of the positive electrode collector may be the same or different.

The solid state battery of the present embodiment is not particularly limited, but examples thereof include an all-solid lithium ion battery and an all-solid lithium metal battery.

The solid state battery of the present embodiment may include a plurality of electrode laminates.

Hereinafter, a case where the solid state battery of the present embodiment is an all-solid lithium metal battery will be described.

The positive electrode collector is not particularly limited, but examples thereof include aluminum foil.

The positive electrode mixture layer contains a positive electrode active material, and may further contain a solid electrolyte, a conductive auxiliary agent, and a binder.

Examples of the positive electrode active material include, but are not limited to, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur as long as the positive electrode active material can absorb and release lithium ions.

The solid electrolyte of the solid electrolyte layer is not particularly limited as long as it is a material capable of conducting lithium ions, and examples thereof include an oxide electrolyte and a sulfide electrolyte (e.g., an argyrodite-type sulfide solid electrolyte).

The negative electrode mixture layer is a lithium metal layer.

The negative electrode collector is not particularly limited, but examples thereof include copper foil.

Although embodiments of the present invention have been described above, the present invention is not limited to the above-described embodiments, and the above-described embodiments may be appropriately modified within the scope of the present invention. For example, the arrangement of the positive electrode and the negative electrode in the solid state battery may be reversed. In this case, the solid state battery includes an electrode laminate including the first solid electrolyte layer, the intermediate layer, the negative electrode, and the second solid electrolyte layer sequentially laminated therein, and the negative electrode includes the negative electrode tab extends therefrom. Here, one of the first solid electrolyte layer or the second solid electrolyte layer includes a porous substrate, and the other of the first solid electrolyte layer or the second solid electrolyte layer does not include a porous substrate. When the electrode laminate is viewed from above, the outer peripheral ends of the first solid electrolyte layer and the second solid electrolyte layer are located outside the outer peripheral ends of the intermediate layer and the negative electrode, and the first solid electrolyte layer and the second solid electrolyte layer are bonded to each other in a region not opposed to the intermediate layer, the negative electrode and the negative electrode tab.

### EXPLANATION OF REFERENCE NUMERALS

100 solid state battery
110, 610 electrode laminate
111 negative electrode
111A negative tab
112 intermediate layer
113 first solid electrolyte layer
114, 614 positive electrode
114A positive electrode tab
115 second solid electrolyte layer
116 substrate
120 laminate film
130 negative tab lead
140 positive tab lead
150, 160 sealant
411a negative electrode collector
411b negative electrode mixture layer
414a positive electrode collector
414b positive electrode mixture layer

What is claimed is:

1. A solid state battery comprising:
an electrode laminate including an intermediate layer, a first solid electrolyte layer, a positive electrode, and a second solid electrolyte layer sequentially laminated on a negative electrode, wherein
the positive electrode includes a positive electrode tab extending therefrom,
one of the first solid electrolyte layer or the second solid electrolyte layer includes a porous substrate,
one other of the first solid electrolyte layer or the second solid electrolyte layer does not include a porous substrate,
when the electrode laminate is viewed from above, outer peripheral ends of the first solid electrolyte layer and the second solid electrolyte layer are located outside an outer peripheral end of the positive electrode, and the first solid electrolyte layer and the second solid electrolyte layer are bonded to each other in a region not opposed to the positive electrode and the positive electrode tab.

2. The solid state battery according to claim 1, wherein
the positive electrode includes a positive electrode collector and positive electrode mixture layers on both surfaces of the positive electrode collector, and
the electrode laminate includes the intermediate layer, the first solid electrolyte layer, the positive electrode, the second solid electrolyte layer, a second intermediate layer, and a second negative electrode sequentially laminated on the negative electrode.

3. The solid state battery according to claim 1, wherein
the positive electrode includes an outer peripheral portion including an insulating frame provided thereon,
when the electrode laminate is viewed from above, outer peripheral ends of the first solid electrolyte layer and the second solid electrolyte layer are located outside an outer peripheral end of the insulating frame, and the first solid electrolyte layer and the second solid electrolyte layer are bonded to each other in a region not opposed to the insulating frame.

4. The solid state battery according to claim 1, wherein the negative electrode includes a lithium metal layer.

5. The solid state battery according to claim 1, wherein the intermediate layer includes a metal capable of being alloyed with lithium, and amorphous carbon.

6. A method of manufacturing a solid state battery according to claim 1, the method comprising:
sequentially laminating a first solid electrolyte layer, a positive electrode, and a second solid electrolyte layer; and
applying a pressure from a side of the other of the first solid electrolyte layer or the second solid electrolyte layer to bond the first solid electrolyte layer and the second electrolyte layer.

7. A solid state battery comprising:
an electrode laminate including, a first solid electrolyte layer, an intermediate layer, a negative electrode, and a second solid electrolyte layer sequentially laminated on a positive electrode, wherein
the negative electrode includes a negative electrode tab extending therefrom,
one of the first solid electrolyte layer or the second solid electrolyte layer includes a porous substrate,
one other of the first solid electrolyte layer or the second solid electrolyte layer does not include a porous substrate,
when the electrode laminate is viewed from above, outer peripheral ends of the first solid electrolyte layer and the second solid electrolyte layer are located outside outer peripheral ends of the intermediate layer and the negative electrode, and the first solid electrolyte layer and the second solid electrolyte layer are bonded to each other in a region not opposed to the intermediate layer, the negative electrode and the negative electrode tab.
